(19) United States
(12) Patent Application Publication
(10) Pub. No.: US 2014/0149191 A1
(43) Pub. Date: May 29, 2014

(54) TECHNIQUE FOR NEGOTIATING WITH A CONSUMER WITHIN A RETAIL ESTABLISHMENT

(71) Applicant: Joseph Luis Aguayo, Chandler, AZ (US)

(72) Inventor: Joseph Luis Aguayo, Chandler, AZ (US)

(73) Assignee: NCR Corporation, Duluth, GA (US)

(21) Appl. No.: 13/688,365

(22) Filed: Nov. 29, 2012

(51) Int. Cl. G06Q 30/06

(52) U.S. Cl. CPC G06Q 30/0611
USPC 705/14.1; 705/26.4; 705/21

(57) ABSTRACT

Techniques for negotiating with a consumer within a retail establishment are provided. A retail Point-Of-Sale (POS) system becomes aware of a consumer looking for a product and having a price comparison for other retailers for that product; the consumer is in a store of the retailer. The retailer generates one or more customized offers to compete with the other retailers and dynamically delivers those customized offers to the consumer while the consumer remains in the store in an attempt to entice the consumer to buy the product at the store.

### BACKGROUND

Automation for goods and services has reached record levels in society. Examples are everywhere from online banking and online retailing to a wide-range of devices and physical appliances that include computing and networking capabilities, which were just wishful dreams only a decade ago. For the most part, these advances have occurred because of breakthroughs in electronics and wireless communications, which have allowed complex processing and network connectivity to be achieved in the smallest of physical devices, such as a smart phone, wearable devices, or other handheld computing devices, for relatively small cost and effort.

These advancements have been embraced by retailers to different degrees and have rapidly transformed their business models. However, an unintended consequence to retailers has been hyper-competition on product price, which has now reached historic portions because a consumer can determine a price for a desired product with near instantaneous speed and without regard to the physical location of the consumer.

For example, Red Laser™ permits a consumer to scan a barcode of a product via his/her smartphone and receive a price comparison on the spot from a variety of online and other physical stores. Thus, retailers are becoming “show rooms” where consumers visit the physical store of a retailer to see and tryout a product but do not buy from that retailer; rather, the consumer often buys the desired product online for a far cheaper price (aka “scan and scram”). The process of using a retailer to try out and view a product is referred to as “show rooming.” Many analysts believe that Best Buy® has experienced severe financial difficulties in recent years because of the increase in consumer “show rooming.”

“Show rooming” is only expected to get worse for physical retail chains as consumers become more conscious about overpaying for products and as the consumers adopt smartphones and apps, such as Red Laser™ with even greater regularity.

A March 2012 Federal Reserve Board study entitled: “Consumer and Mobile Financial Services” indicates that 19% of respondents reported using their mobile phones to comparison shop while physically present in a retail store; 12% indicated that they used a barcode scanning app, such as Red Laser™, to perform the price comparison; and 65% changed where they planned to make a purchase after comparing prices on their mobile phones while in a store. Consumers were also asked: “what purpose would you like to use your mobile phone for if made available to you?” An astonishing 48% responded with an answer of: “comparison shopping.”

It is clear that if physical retailers do not change the manner in which they conduct business with a consumer, then these retailers are likely to be out of business in the not too distance future.

### SUMMARY

In various embodiments, techniques for negotiating with a consumer within a retail establishment are presented. According to an embodiment, a method for retail negotiation is provided.

Specifically, a product identifier for a candidate product and a list of offered prices from competing retailers for the candidate product are received. Next, a counter offer for a product is determined that is comparable to the candidate product; the product available in a physical retail store where a consumer is present with the list. Finally, the counter offer is communicated to a handheld device of the consumer while the consumer is present in the store.

### BRIEF DESCRIPTION OF THE DRAWINGS

FIG. 1 is a diagram of a method for retail negotiation, according to an example embodiment.

FIG. 2 is a diagram of another method for retail negotiation, according to an example embodiment.

FIG. 3 is a diagram of a retail negotiation system, according to an example embodiment.

### DETAILED DESCRIPTION

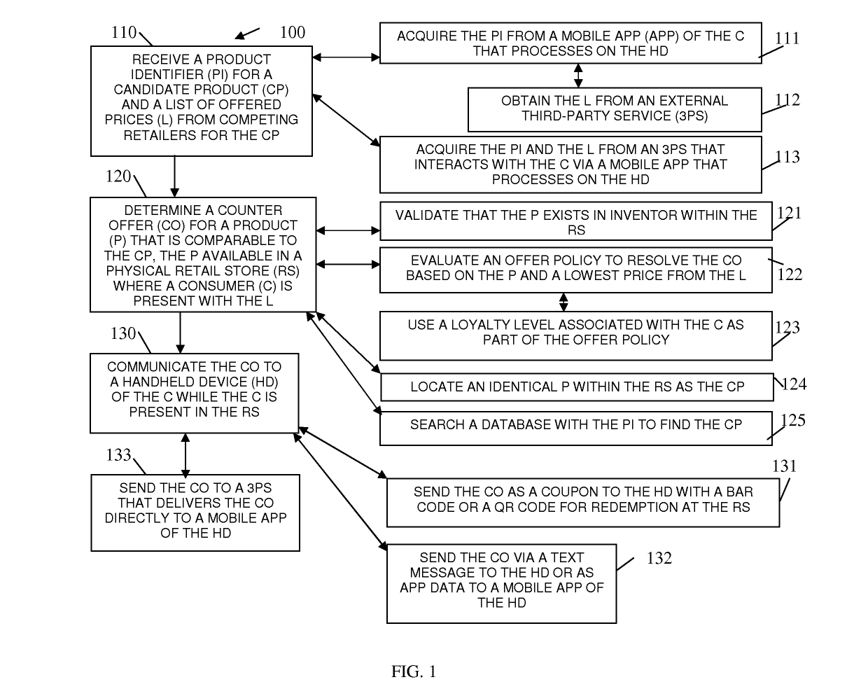

FIG. 1 is a diagram of a method 100 for retail negotiation, according to an example embodiment. The method 100 (hereinafter “retail negotiation manager”) is implemented as instructions programmed and residing on a non-transitory computer-readable (processor-readable) storage medium and executed by one or more processors. The processors are specifically configured and programmed to process the retail negotiation manager. The retail negotiation manager operates over a network. The network is wired, wireless, or a combination of wired and wireless.

In an embodiment, the retail negotiation manager executes on processors of a server or a cloud processing environment. In some instances, the retail negotiation manager processes on a Point-Of-Sale (POS) terminal or server (POS device) of a retailer. The POS device can be, in some embodiments, a thin client that interacts with a remote server having the retail negotiation manager. Moreover, the retail negotiation manager can process on a Virtual Machine (VM) where the underlying physical processing environment and physical processors can vary depending upon the installation of the VM.

As will become apparent from the teachings herein and below, the retail negotiation manager gives physical retailers an opportunity to compete with online retailers and win over price-sensitive consumers while those consumers are in the retailers' stores. This can give the physical retailers a chance to reinvent themselves, creating more competition and better value for consumers. The techniques herein: 1) identify if a product or similar product is inventoried in the store; 2) determine if the price is within a predetermined range of a best price available from comparison shopping; 3) determine if the price can be reduced to the predetermined range; and 4) calculate alternative offers when a price match is unrealistic, such as determining how much a consumer may need to spend to get the price match on other goods within the store, and the like.

At 110, the retail negotiation manager receives a product identifier (or product identifying information) for a candidate product along with a list of offered product prices from competing retailers. So, the retail negotiation manager acquires information related to the product that a consumer is desiring to purchase or may be desiring to purchase based on the consumer being present within a physical retail store and making a request for the list. The retail negotiation manager may be interacting with an app on the consumer's handheld or mobile device (phone or tablet) or may be interacting with a third-party price comparison service (which is interacting with a mobile app on the mobile device of the consumer). One such mobile app is Red Laser™ albeit it is noted that others exists as well. In situations where the retail negotiation manager is interacting with a third-party service, the third-party service is modified and enhanced to interact with the retail negotiation manager to achieve the processing described herein or to achieve at least portions of the processing described herein.

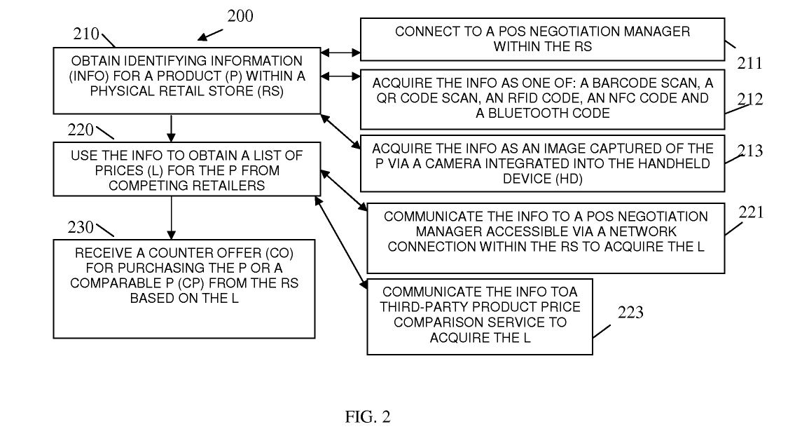

According to an embodiment, at 111, the retail negotiation manager acquires the product identifier from a mobile app of the consumer that processes on the handheld device of the consumer (phone, tablet, etc.). An example of such a mobile app is provided below with reference to the FIG. 2.

Continuing with the embodiment of 111 and at 112, the retail negotiation manager obtains the list from an external third-party service (such as a price comparison service). So, the retail negotiation manager can acquire the product identifier from the mobile app and then independently acquire the list from the third-party service.

In still another case, at 113, the retail negotiation manager acquires the product identifier and the list both from an external third-party service interacting with the consumer via a mobile app that processes on the handheld device of the consumer. Here, the mobile app is directly associated and distributed by the third-party service and the third-party service id modified to interact with the retail negotiation manager.

At 120, the retail negotiation manager determines a counter offer for a product that is comparable to the candidate product. The product is available within a physical retail store where a consumer is present with the list. The counter offer can be dynamically resolved in a variety of manners, some of which are presented below.

In an embodiment, at 121, the retail negotiation manager validates that the product exists within inventory within the physical retail store. So, a search of inventory is done by the retail negotiation manager to ensure that the product is available.

In one situation, at 122, the retail negotiation manager evaluating an offer policy to resolve the counter offer based on the product and a lowest price from the list. The offer policy can define a variety of conditions. For example, the counter offer may actually be higher than the lowest price by a certain range; this may be acceptable because the consumer can take the product home immediately so it may be worth more the consumer than the lowest price. The counter offer may also get to the lowest price or close to it my establishing other conditions such as the consumer being required to spend extra money on other products or buying two or more of the products. In fact, the conditions that generate the counter offers are embedded for dynamically evaluation within the offer policy.

Continuing with the embodiment of 122 and at 123, the retail negotiation manager uses a loyalty level for the consumer with a retailer of the physical retailer store as part of the offer policy. That is, if a consumer is a frequent and most loyal consumer of the retailer than the retailer may be willing to take a loss or partial loss on the product to retail the consumer and make the consumer happy. The consumer may also be able to reduce the price to achieve the counter offer via redemption of loyalty points.

According to an embodiment, at 124, the retail negotiation manager locates an identical product within the physical retail store as the comparable product.

In another case, at 125, the retail negotiation manager searches a database with the product identifier to find the comparable product. So, exact matches do not have to be made but similar products from different manufacturers can be located via search.

At 130, the retail negotiation manager communicates the counter offer to a handheld device of the consumer while the consumer is present in the store. In other words, the consumer is present in the store when the counter offer is communicated to the handheld device.

In an embodiment, at 131, the retail negotiation manager sends the counter offer as a coupon to the handheld device with a bar code or a Quick Response (QR) code for immediate redemption at the physical retail store. The coupon may also include, optionally, an expiration that may be time of date and calendar date specific. So, the coupon may expire an hour after it is delivered to the consumer. The coupon may also automatically expire when the handheld device is detected as having left the physical retail store.

In another case, at 132, the retail negotiation manager sends the counter offer via a text message to the handheld device or as app data to a mobile app of the handheld device.

In still another situation, at 133, the retail negotiation manager sends the counter offer to a third-party service that delivers the counter offer directly to a mobile app of the handheld device.

FIG. 2 is a diagram of another method for retail negotiation, according to an example embodiment. The method 200 (hereinafter “negotiation app”) is implemented as instruction and programmed within a non-transitory computer-readable (processor-readable) storage medium that executes on one or more processors of a handheld device; the processors of the handheld device are specifically configured to execute the negotiation app. The negotiation app is operational over a network; the network is wired, wireless, or a combination of wired and wireless.

Whereas the retail negotiation manager (the FIG. 1 above) describes processing associated with retail POS processing from one or more devices controlled by or accessible to a retailer, the negotiation app describes processing associated with retail negotiation from the perspective of a consumer's device for a consumer negotiating on price for a good or service with that retailer. So, the negotiation app interacts with the retail negotiation manager (the FIG. 1 above).

In an embodiment, the negotiation app can be a commercially available app or third-party service, such as Red Laser® and others, which is modified and enhanced (in the manners discussed herein and below with respect to the FIG. 2) to interact with the retail negotiation manager (the FIG. 1 above).

At 210, the negotiation app obtains identifying information for a product within a physical retail store. The identifying information can include a variety of types of information.

According to an embodiment, at 211, the negotiation app connecting the negotiation app to a POS negotiation manager within the physical retail store, such as the negotiation manager represented by the FIG. 1 above.

In an embodiment, at 212, the negotiation app acquires the identifying information as one of: a bar code scan, a QR code, a Radio Frequency Identifier (RFID) code, a Near Field Communication (NFC) code, and a Bluetooth code.

In yet another situation, at 213, the negotiation app acquires the identifying information as an image captured of the product via a camera integrated into the handheld device. Here, the handheld device can even been wearable apparel, such as goggles or a device that automatically detects or captures the image of the product when the consumer is fixed in front of it.

At 220, the negotiation app uses the identifying information to obtain a list of prices for the product from competing retailers.

In an embodiment, at 221, the negotiation app communicates the identifying information to a POS negotiation manager accessible via a network connection within the physical retail store to acquire the list. Here, the POS negotiation manager may perform the search to acquire the list for the consumer or may interact with a third-party service to acquire the list.

In another case, at 222, the negotiation app communicates the identifying information to a third-party product price comparison service to acquire the list.

At 230, the negotiation app receives a counter offer for purchasing the product or a comparable product from the physical retail store based on the list.

It is noted that depending upon retailer policy and/or the loyalty level of the consumer that the counter offers provided by the retail negotiation manager (the FIG. 1) can be iterative with the consumer until a condition being proposed is either at an impasse with either the retailer and/or the consumer.

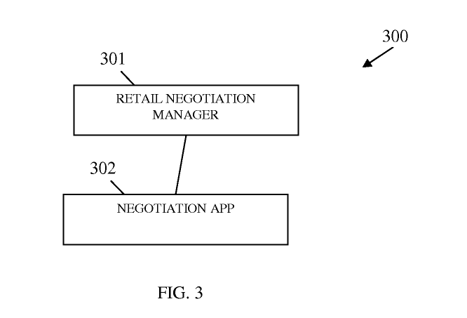

FIG. 3 is a diagram of a retail negotiation system 300, according to an example embodiment. The components of the retail negotiation system 300 reside in memory or in a non-transitory computer-readable medium as executable instructions that are processed on one or more processors of one or more devices. Moreover, the components are operational over a network; the network wired, wireless, or a combination of wired and wireless.

In an embodiment, the retail negotiation system 300 implements, inter alia, the retail negotiation manager of the FIG. 1 and the negotiation app of the FIG. 2.

The retail negotiation system 300 includes a retail negotiation manager 301 and a negotiation app 302. Each of these and their interactions with one another will now be discussed in turn.

The retail negotiation system 300 includes a server machine or a cloud processing environment having memory or non-transitory computer-readable storage media with the retail negotiation manager 301. Processors of the server machine or the cloud processing environment are specifically configured to execute the retail negotiation manager 301. Example processing associated with the retail negotiation manager 301 was presented in detail above with respect to the method 100 of the FIG. 1.

The retail negotiation manager 301 is configured to identify the consumer within a physical retail store of a retailer along with a product identifier for a product and a list of prices for the product from competing retailers of the retailer. The retail negotiation manager 301 is further configured to develop a counter offer based on the list and to deliver the counter offer to the mobile device of the consumer via the negotiation app 302 while the consumer is within the physical retail store.

The retail negotiation system 300 also includes another server or cloud processing environment that configures and distributes the negotiation app 302 to a handheld device of a consumer. Example processing associated with the negotiation app 302 was presented in detail above with respect to the method 200 of the FIG. 2.

The negotiation app 302 is configured to capture identifying information from a handheld device of the consumer (can also be a wearable device—in fact any mobile device) for a product and acquire the list. The product and the list provided to the retail negotiation manager 301 resulting in the counter offer being presented via the negotiation app 302 to the consumer while the consumer is still present within the physical store of the retailer.

According to an embodiment, the negotiation app 302 is further configured to redeem the counter offer for the consumer when the consumer purchases the product from the retailer within the physical store.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A processor-implemented method programmed in memory or a non-transitory processor-readable medium and to execute on one or more processors of a device configured to execute the method, comprising:
receiving, at the device, a product identifier for a candidate product and a list of offered prices from competing retailers for the candidate product;
determining, at the device, a counter offer for a product that is comparable to the candidate product, the product available in a physical retail store where a consumer is present with the list; and
communicating, from the device, the counter offer to a handheld device of the consumer while the consumer is present in the physical retail store.

2. The method of claim 1, wherein receiving further includes acquiring the product identifier from a mobile app of the consumer that processes on the handheld device.

3. The method of claim 2, wherein acquiring further includes obtaining the list from an external third-party service.

4. The method of claim 1, wherein receiving further includes acquiring the product identifier and the list from an external third-party service interacting with the consumer via a mobile app that processes on the handheld device.

5. The method of claim 1, wherein determining further includes validating that the product exists in inventory within the physical retail store.

6. The method of claim 1, wherein determining further includes evaluating an offer policy to resolve the counter offer based on the product and a lowest price from the list.

7. The method of claim 6, wherein evaluating further includes using a loyalty level associated with the consumer as part of the offer policy.

8. The method of claim 1, wherein determining further includes locating an identical product within the physical retail store as the comparable product.

9. The method of claim 1, wherein determining further includes searching a database with the product identifier to find the comparable product.

10. The method of claim 1, wherein communicating further includes sending the counter offer as a coupon to the handheld device with a bar code or Quick Response (QR) code for redemption at the physical retail store.

11. The method of claim 1, wherein communicating further includes sending the counter offer via a text message to the handheld device or as app data to a mobile app of the handheld device.

12. The method of claim 1, wherein communicating further includes sending the counter offer to a third-party service that delivers the counter offer directly to a mobile app of the handheld device.

13. A processor-implemented method programmed in memory or a non-transitory processor-readable medium and to execute on one or more processors of a handheld device configured to execute the method, comprising:
obtaining, by the handheld device, identifying information for a product within a physical retail store;
using, via the handheld device, the identifying information to obtain a list of prices for the product from competing retailers; and
receiving, at the handheld device, a counter offer for purchasing the product or a comparable product from the physical retail store based on the list.

14. The method of claim 13, wherein obtaining further includes connecting to a Point-Of-Sale (POS) negotiation manager within the physical retail store.

15. The method of claim 13, wherein obtaining further includes acquiring the identifying information as one of: a barcode scan, a Quick Response (QR) code scan, a Radio Frequency Identifier (RFID) code, a Near Field Communication (NFC) code, and a Bluetooth code.

16. The method of claim 13, wherein obtaining further includes acquiring the identifying information as an image captured of the product via a camera integrated into the handheld device.

17. The method of claim 13, wherein using further includes communicating the identifying information to a Point-Of-Sale (POS) negotiation manager accessible via a network connection within the physical retail store to acquire the list.

18. The method of claim 13, wherein using further includes communicating the identifying information to a third-party product price comparison service to acquire the list.

19. A system, comprising:
a server having memory configured with a retail negotiation manager that executes on one or more processors of the server; and
the server or a different server configured to distribute a negotiation app to a mobile device of a consumer;
wherein the retail negotiation manager is configured to identify the consumer within a physical retail store of a retailer along with a product identifier for a product and a list of prices for the product from competing retailers of the retailer, and the retail negotiation manager is further configured to develop a counter offer based on the list and deliver the counter offer to the mobile device of the consumer via the negotiation app while the consumer is within the physical retail store.

20. The system of claim 19, wherein negotiation app is further configured to redeem the counter offer for the consumer when the consumer purchases the product from the retailer within the physical retail store.
